(19) United States
(12) Patent Application Publication
(10) Pub. No.: US 2013/0260822 A1
(43) Pub. Date: Oct. 3, 2013

(54) Notebook with Mobile Telephone Receptacle

(71) Applicant: Shing-Wai David Wu, Kowloon (CN)

(72) Inventor: Shing-Wai David Wu, Kowloon (CN)

(21) Appl. No.: 13/435,391

(22) Filed: Mar. 30, 2012

(51) Int. Cl. H04M 1/00

(52) U.S. Cl. 455/556.1

(57) ABSTRACT

A notebook computer device has a body and a display panel pivotally attached to the body. A receptacle is provided in the body to receive a mobile touch screen telephone in an orientation to present the telephone's touch screen to the user for use as a notebook computer touchpad while viewing the display panel. A display interface is provided for relaying signals from the mobile telephone so that user-manipulation of the touch screen is conveyed to the display panel.

### BACKGROUND OF THE INVENTION

The present invention relates to portable computers such as notebooks or laptops. The invention more particularly, although not exclusively, relates to a device in the style of a notebook computer in which a mobile telephone can be used as a touchpad.

Modern mobile telephones such as the Apple iPhone have a touch screen display by which the user can manipulate the software. The screen however is small and its display area is limited. There are numerous applications available for such telephones and many of these would benefit from a larger display area. Of course “tablets” are available with a larger display area, but these are relatively expensive and could represent an unnecessary expenditure for those already owning an iPhone for example.

### SUMMARY

Briefly stated, a notebook style computer device comprises a keyboard and a large display screen, wherein the device is adapted to receive a mobile telephone in such a way that the telephone's small display can be used as a touchpad—the use of which is communicated to the large screen.

A notebook computer device comprises:

a body;

a display panel pivotally attached to the body;

a receptacle in the body adapted to receive a mobile touch screen telephone in such orientation as to present the telephone's touch screen to the user for use as a notebook computer touchpad while viewing the display panel; and

a display interface for relaying signals from a mobile telephone received by the receptacle to the display panel.

Preferably, the display interface is wired.

Preferably, the wired interface is an HDMI interface.

The notebook computer device can further comprise a keyboard upon the body adjacent to the receptacle.

The notebook computer device can further comprise a keyboard interface for communicating key strokes of the keyboard to a mobile telephone received by the receptacle.

Preferably, the keyboard interface is wireless, but alternatively it could be hard-wired.

Preferably, the wireless interface is a Bluetooth interface (typically V2.1 or 4.0).

The notebook computer device can further comprise a removable cover attached to the body to provide access to the receptacle. An alternative to this is that the mobile telephone could be installed from above and clicked into place in the receptacle. In this case no removable cover would be required at the back.

Preferably, the cover is located at a side of the body opposite to that at which the keyboard is located.

### BRIEF DESCRIPTION OF THE DRAWINGS

A preferred form of the present invention will now be described by way of example with reference to the accompanying drawings, wherein:

FIG. 1 is a schematic perspective illustration of a notebook computer device with a mobile telephone installed therein for use as a touchpad;

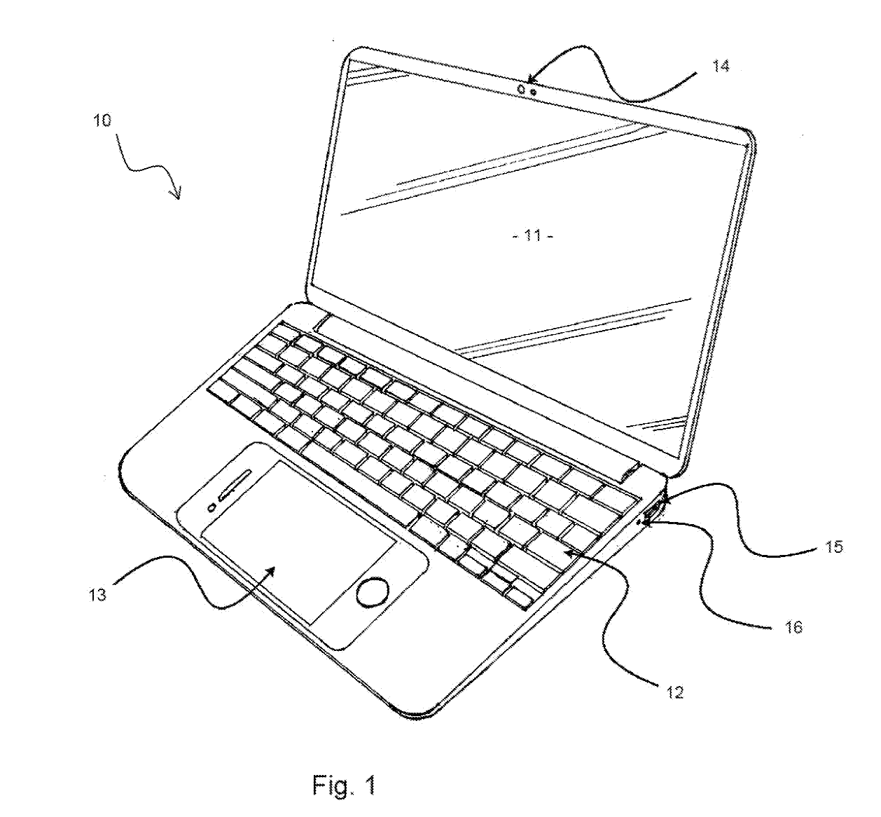

FIG. 2 is a schematic perspective illustration of the notebook computer device depicting hidden detail;

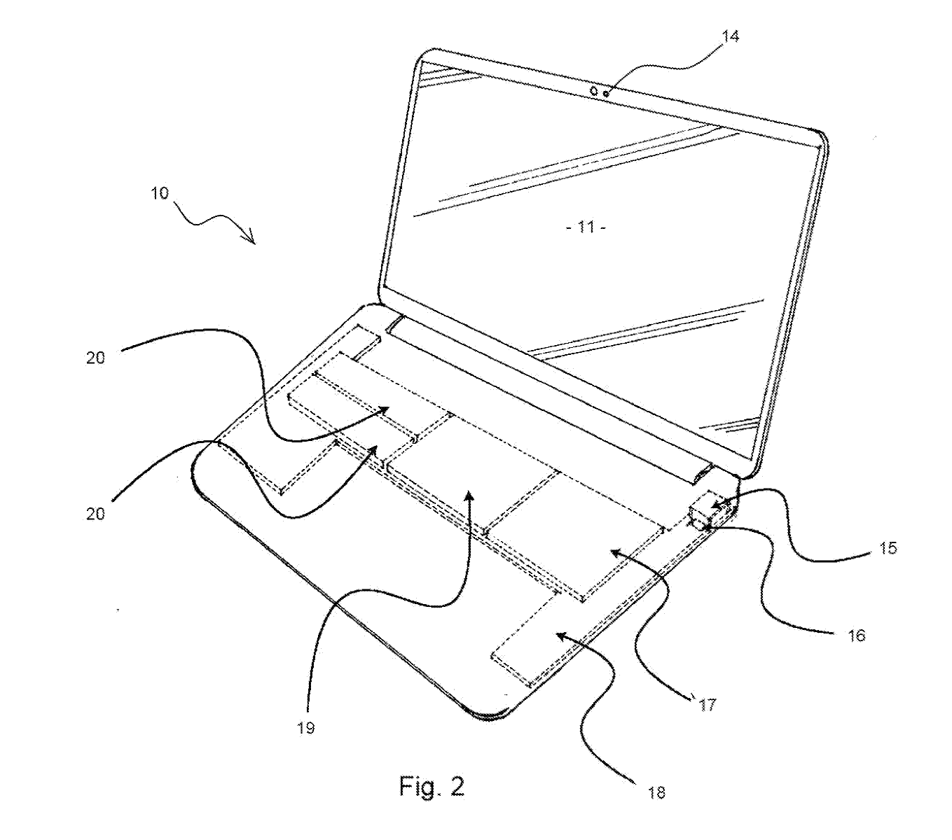

FIG. 3 is a schematic perspective illustration of the notebook computer device as viewed from below;

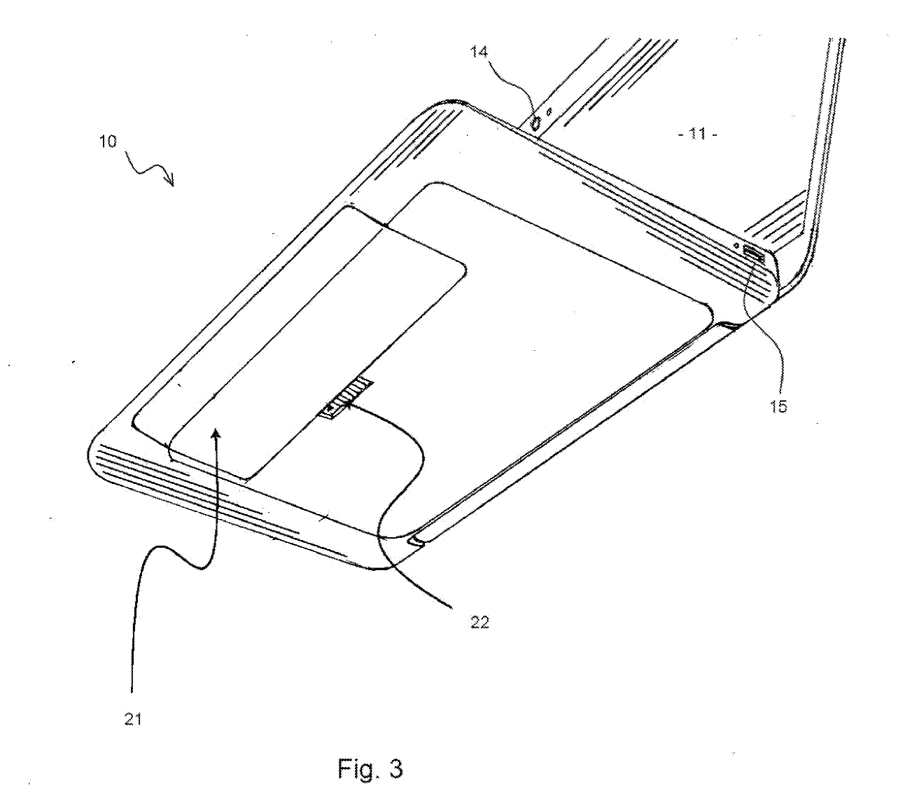

FIG. 4 is a schematic perspective illustration of the notebook computer device from as viewed from below and depicting a receptacle having its cover plate removed for insertion of a mobile telephone; and

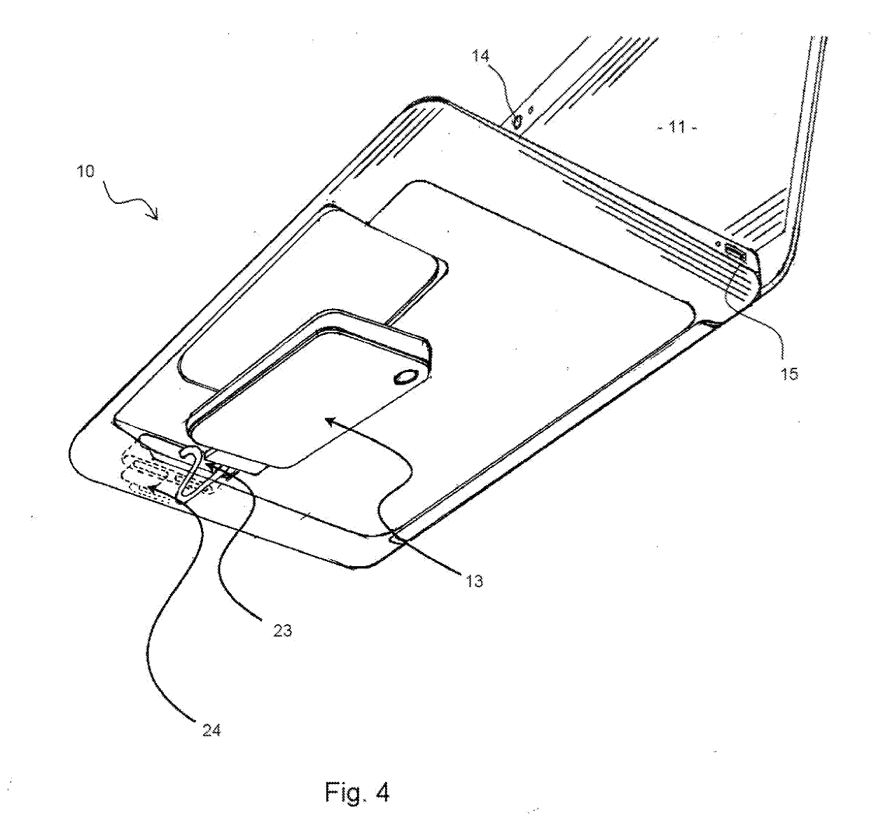

FIG. 5 is a schematic perspective illustration of the notebook computer device from below, showing hidden detail.

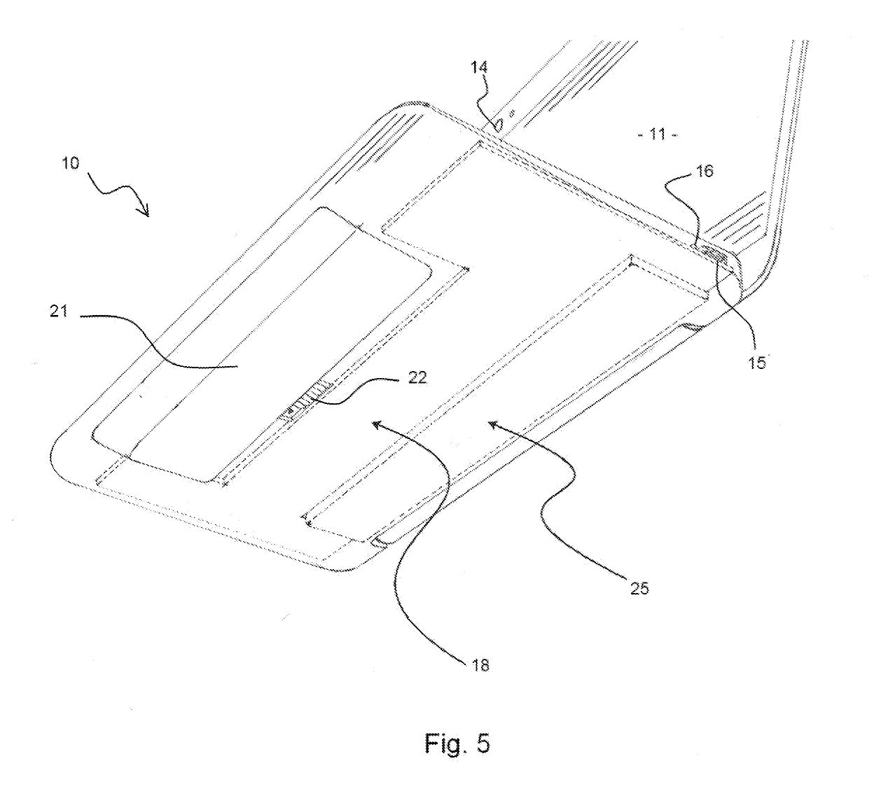

### DETAILED DESCRIPTION

In the accompanying drawings there is depicted schematically a notebook computer device 10. Although taking the general physical form of a typical notebook computer, the device 10 need not have its own touchpad and need not have its own internal data and/or video processors. In some respects, such a version might be regarded as a shell. In the illustrated embodiment however there are certain internal components to be described.

The device 10 comprises a display panel 11 and a body having a keyboard 12. The display panel 11 is attached by a hinge to the body. A mobile telephone such as an Apple iPhone 4 or 4S (or any mobile telephone having a touchscreen) is installed into a recess of the body so that its touchscreen is presented below the keyboard 12 for use as a notebook touchpad.

A camera lens 14 is provided above the top of the display panel 11. A USB socket 15 is provided in the body so that a USB battery-charging cable can be connected to the device. A power indicator LEDs 16 is provided alongside the USB socket.

The keyboard 12 communicates with the installed mobile telephone via a wireless (typically Bluetooth) connection.

In the illustrated embodiment, the notebook device comprises a CPU 17, PCB 18, a GPU 19 and RAM 20. These features are optional. Depending on the chosen application and pricing, reliance for the functions afforded by these components can instead be placed solely on the installed mobile telephone's internal capabilities.

The mobile telephone receptacle is accessed via a removable cover 21 provided at the underside of the body. In an alternative, the mobile telephone could be snapped-in from above and no removable cover would be required however. A latch 22 is provided to enable removal of the cover 21. The receptacle is sized and configured to firmly receive a particular model of mobile telephone. For example an iPhone 4 or 4S compatible device will receive an iPhone snugly and perhaps even comprise snap-engagement tabs to firmly engage and support the telephone so that its touchscreen is presented firmly and at an appropriate position. In the embodiment depicted, a short Apple Digital AV Adapter connects the mobile telephone to the device via an HDMI receptacle 24.

The notebook device would typically also include a built-in rechargeable battery 25.

In use, actions performed by the installed mobile telephone 13 are conveyed to the notebook device for replication on the display panel 11. Manipulation of the mobile telephone's touch screen is therefore relayed to the display panel 11. The keyboard 12 communicates with the installed mobile telephone wirelessly as a discoverable Bluetooth device for example.

The keyboard 12 is typically a paper thin touch sensitive type. Alternatively, the keys could be of tactile or island type. The display panel 11 is typically a high resolution nine to ten inch display capable of 720 P or 1080 P for iPhone 4S movies. The iPhone 4S would be docked into the receptacle and used as a touchpad. Depending on the particular configuration of the receptacle and receptacle cover 21, the mobile telephone can be loaded from the top or the bottom or slid in from the leading edge of the body and secured in front of the keyboard. The iPhone 4S screen becomes the touchpad and the images on the iPhone screen are replicated on the large display panel. This gives the user a netbook type of feeling.

The keyboard typically of 78 keys preferably uses Bluetooth to connect to iPhone (although hard wiring is an alternative) while the display typically use direct connection to the iPhone's 30 pin connector.

The case is typically of sturdy plastics or metal material with a hinge for the display panel. The unit will come with various size of battery to power the keyboard and the TFT screen. Battery capacity may vary from 4,000 mAh to as much as 9,000 mAh Li-Ion or Li-Polymer battery sufficient to power up the unit for 4-8 hours. An AC adapter will be used to charge the internal battery within 4 to 6 hours.

The display panel would typically be an A-grade nine to ten inch active matrix TFT panel with resolution of 1024 by 768 with 16.7 million color capability. An anti-glare panel surface treatment could be provided as well as LED backlighting. Brightness would typically be greater than 300 nits. Video input is typically via HDMI 1.3.

It should be appreciated that modifications and alterations obvious to those skilled in the art are not to be considered as beyond the scope of the present invention. For example, the notebook computer device could include speakers and the HDMI interface would of course communicate audio information from a mobile telephone to the speakers. Furthermore in a different configuration, the mobile telephone (typically an iPhone 4S) could remain detached and be linked wirelessly with the notebook device so that the display panel simply replicates the screen of the mobile telephone. Furthermore, a quick-release mechanism could be incorporated into the device to eject the mobile telephone.

1. A notebook computer device comprising:
a body;
a display panel pivotally attached to the body;
a receptacle in the body adapted to receive a mobile touch screen telephone in such orientation as to present the telephone's touch screen to the user for use as a notebook computer touchpad while viewing the display panel; and
a display interface for relaying signals from a mobile telephone received by the receptacle to the display panel.

2. The notebook computer device of claim 1, wherein the display interface comprises a wired interface.

3. The notebook computer device of claim 2, wherein the wired interface is an HDMI interface.

4. 4. The notebook computer device of claim 1, further comprising a keyboard upon the body adjacent to the receptacle.

5. The notebook computer device of claim 4, further comprising a keyboard interface for communicating key strokes of the keyboard to a mobile telephone received by the receptacle.

6. The notebook computer device of claim 5, wherein the keyboard interface comprises a wireless interface.

7. The notebook computer device of claim 5, wherein the wireless interface is a Bluetooth interface.

8. The notebook computer device of claim 5, further comprising a removable cover attached to the body to provide access to the receptacle.

9. The notebook computer device of claim 8, wherein the cover is located at a side of the body opposite to that at which the keyboard is located.
